(19) United States
(12) Patent Application Publication
(10) Pub. No.: US 2010/0015501 A1
(43) Pub. Date: Jan. 21, 2010

(54) Fuel-Cell Cartridge Connector

(76) Inventors: Minoru Kanno, Shizuoka (JP); Takayuki Suzuki, Shizouka (JP); Makoto Sato, Shizuoka (JP)

Correspondence Address: TROJAN LAW OFFICES, 9250 WILSHIRE BLVD, SUITE 325, BEVERLY HILLS, CA, 90212, US

(21) Appl. No.: 12/373,019

(22) PCT Filed: May 30, 2007
(86) PCT No.: PCT/US07/70003

§ 371 Date: Apr. 21, 2009

(30) Foreign Application Priority Data
Jul. 20, 2006 (JP) JP 2006-198208

(51) Int. Cl. H01M 2/12

(52) U.S. Cl. 429/34

(57) ABSTRACT

The problem to be solved is to protect the connector parts of the fuel-cell cartridge and the fuel-cell holding appliance from damage when an external rotating force that exceeds a rated value is applied to the cartridge case. The means for solving the problem is a fuel-cell cartridge connector (1) comprising a connecting projection member (12) that is held in a cartridge case that covers a fuel container that contains fuel to be supplied to a fuel cell, said connecting projection member having one end for insertion into the aforementioned fuel container and the other end for contact with the front end of a fuel supply mouth and for attachment to said fuel supply mouth. The aforementioned connector is intended for removably connecting to an appliance that contains the aforementioned fuel cell and has a connection portion that corresponds to the connecting projection member (12). The fuel-cell cartridge connector (1) is further provided with a rotation mechanism that allows rotation of the cartridge case └relative to the connector┘ when a rotating force that exceeds a predetermined value is applied to the cartridge in the condition when the connecting projection member is connected to the connection portion and the fuel receiving opening communicates with the fuel supply mouth.

### FIELD OF THE INVENTION

The present invention relates to a fuel-cell cartridge connector, and more specifically, to a mechanism for connection to appliances that use fuel cells.

### BACKGROUND OF THE INVENTION

A fuel cell is known in the art as an energy-conversion appliance in which hydrogen ions pass through an electrolyte membrane that separates oxygen from hydrogen, methanol, or a similar fuel, whereby the chemical reaction that occurs between hydrogen and oxygen generates electricity. At the present time, fuel cells have found some practical applications since it is expected that operational temperature may be low and that the appliance can be reduced in size. Developments have been carried out in the direction of fuel-cell use as electrical power sources for long-lasting and continuous operation of notebook-type computers and various portable appliances such as mobile phones.

Generally, a fuel cell that is used as a power source of a mobile appliance is built into the appliance, and when the fuel contained in such a source is exhausted, it can be replenished by a new portion of fuel for direct conversion into electrical energy. The aforementioned built-in fuel cells are filled with fuel by means of fuel containers (fuel-cell cartridges) (see Japanese Unexamined Patent Application Publication (Kokai) 2006-54055).

### DESCRIPTION OF THE INVENTION

The aforementioned fuel-cell cartridges are normally provided with fuel-cell cartridge connectors for removably connecting and fixing the cartridges to the connection portions of the aforementioned appliances that contain fuel cells (hereinafter referred to simply as “appliances”) for filling the fuel cell with fuel. In order to prevent possibility of connecting a wrong fuel-cell cartridge that contains fuel of a different type, the connector is provided with key grooves and/or key projections that correspond to respective key projections and/or key grooves that allow connection and fixation to a connection portion of only a specified appliance.

However, when in the state of connection to the connection portion of the appliance by means of the aforementioned fuel-cell cartridge connector a force that is applied to the fuel-cell cartridge in the rotation direction exceeds a normally used value and is transmitted to the connector, this may damage the connector, i.e., the parts on the cartridge side or the connection portion of the appliance.

Based on the above information, it is an object of the present invention to provide a fuel-cell cartridge connector that protects the fuel-cell holding appliance and a fuel-cell cartridge from damage when external force is applied to the cartridge in the direction of cartridge rotation. A fuel-cell cartridge connector of the present invention comprises:

a connecting projection member that is held in a cartridge case that covers a fuel container that contains fuel to be supplied to a fuel cell, said connecting projection member having one end for insertion into the aforementioned fuel container and the other end for contact with the front end of a fuel supply mouth and for attachment to said fuel supply mouth;

said fuel-cell cartridge connector being intended for removably connecting to an appliance that contains the aforementioned fuel cell and has a connection portion that has a fuel-receiving opening that faces outside and is intended for receiving the fuel, and that corresponds to the aforementioned connecting projection member;

said fuel-cell cartridge connector being characterized by further comprising a rotation mechanism that causes the cartridge case to rotate when a rotating force that exceeds a predetermined value is applied thereto when the connecting projection member is connected to the connection portion and the fuel receiving opening communicates with the fuel supply mouth.

In the context of the present invention, the phrase “a rotating force that exceeds a predetermined value” means a damaging force that is beyond the scope of the values rated for a force that can be applied to the fuel-cell cartridge in the rotation direction of the cartridge during normal operation.

In the fuel-cell cartridge connector of the present invention, the aforementioned rotation mechanism may comprise engagement means and a rotation-stopping engagement element that is

In the fuel-cell cartridge connector of the present invention, the connecting projection member and the connection portion may form connection engagement keys from corresponding grooves and/or projections, respectively; the aforementioned engagement element being formed in a position that is specified for said grooves and/or projections of the connection engagement keys.

Furthermore, in the fuel-cell cartridge connector of the present invention, the engagement means can be provided with an adjustable mechanism for setting the aforementioned predetermined value.

Since the fuel-cell cartridge connector made according to the present invention is provided with a rotation mechanism that allows turning of the cartridge case, when in the condition of connection of the connection portion to the connecting projection member a rotation force applied to the cartridge case exceeds a predetermined value, the above mechanism protects the connection and fixation parts from application of the aforementioned rotation force that exceeds a predetermined value when the cartridge case is rotated. Thus, the connector, i.e., the fuel-cell holding appliance, and the cell cartridge will be protected from damage.

When the aforementioned rotation mechanism of the fuel-cell cartridge connector has a connecting projection member that engages the engagement means of the cartridge case, rotation of the cartridge case can be stopped in an arbitrary position by selecting a position in which the engagement element is to be formed. Thus, during normal operation the cartridge case remains stopped in the aforementioned arbitrary position, and only the cartridge case will turn when the rotation force applied to the cartridge case exceeds the predetermined value.

When the aforementioned connecting projection member and the connection portion of the fuel-cell cartridge connector have the connection engagement keys formed by the groove and/or projections, respectively, the fuel-cell cartridge and the appliance can be connected to each other by means of the aforementioned engagement keys, and since the engagement element can be formed in the position specified for the positions of the groove and/or projections of the aforementioned connection engagement keys, it becomes possible to specify the position of the connection engagement keys for connection to the appliance and thus to exclude difficulties in connection to the appliance and to facilitate attachment of the connector to the appliance by rotating the cartridge and varying the position of the key groove relative to the cartridge case.

When the aforementioned engagement means of the fuel-cell cartridge connector are provided with an adjustment mechanism for setting the aforementioned predetermined value [of the rotation force], it becomes possible to adjust the predetermined value of the external force which allows initiation of the rotation of the cartridge case, the aforementioned predetermined value being selected in accordance with the strength of the respective parts of the appliance and of the fuel-cell cartridge.

### DESCRIPTION OF THE PREFERRED EMBODIMENTS

A connector 1 for the fuel cell cartridge made in accordance with one embodiment of the present invention (hereinafter referred to as “connector”) will now be described in more detail with reference to the accompanying drawings, wherein FIG. 1 is an exploded three-dimensional view of the fuel cell cartridge of the present embodiment, FIG. 2 is a three-dimensional view of the connector 1 shown in FIG. 1, and FIG. 3 is a view that explains the mechanism of rotation of the connector 1 shown in FIG. 1. Given below is an explanation as to how the connection portion of the appliance that incorporates a fuel cell (which is not shown in the drawings) is connected to the connector of the present invention.

As shown in FIG. 1, connector 1 of the fuel cell cartridge of the present embodiment has a large-diameter cylindrical portion 11 that is retained in a cartridge case 2 which covers a fuel container 2F (see FIG. 4) [designation 2F is present in FIG. 3 but not in FIG. 4—tr. note] that contains fuel to be supplied to the fuel cell installed in a fuel-cell holding appliance, and a cylindrical connecting projection member 12 that projects in the upward direction from the upper side of the aforementioned large-diameter cylindrical portion 11. At its lower end, the large-diameter portion 11 has a fuel-supply opening (not shown in the drawings) which is located substantially in the center of the large-diameter portion 11, passes through the inner part of fuel container 2F, and serves to supply fuel to the fuel cell which faces the outer side of the aforementioned connector.

As shown in FIGS. 1 and 2, the large-diameter portion 11 has an annular groove 111 formed on its outer periphery approximately in the middle of its width. The outer periphery of the large-diameter portion has a rotation-stopping engagement element 112 in the form of an inwardly directed V-shaped groove, which is formed below aforementioned large-diameter portion 11.

Cartridge case 2 consists of a box-like case body 21, one side of which is open, and a case cover 22, which is telescopically inserted into the aforementioned open side of case body 21. Cartridge case body 21 is formed with four cylindrical lugs located in the corners of the case body cavity and having threaded openings 21a, while case cover 22 has four openings 22a aligned with positions of threaded openings 21a of the casing for attaching case cover 22 to case body 21 by means of screws (not shown), which are screwed into the aforementioned threaded openings 21a. One side wall of case body 21 has a cutout 211, which is directed from the outer end face of the open side of the case body toward the bottom thereof and has a semicircular end. The above-described method of attachment of cover 22 to case body 21 should not be construed as limiting the scope of the invention, and other methods of attachments, e.g., fusion or adhesion, can be used.

A recess 212 is formed in the bottom of case 21 near cutout 211 of the side wall. This recess 212 is intended for telescopic insertion of a resilient engagement element 23 made, e.g., from metal. Resilient element 23 can be made, e.g., in the form of a thin elongated plate, which, when telescopically inserted into recess 212, forms a V-shaped projection 23a engageable with rotation-stopping engagement element 112 of aforementioned large-diameter portion 11. Projection 23a possesses resiliency in the direction of its height. Although it was mentioned that resilient engagement element 23 is made from metal, it can be made from any other resilient material, e.g., plastic or rubber.

On the edge portion of its side that faces case body 21, case cover 22 has a plate that projects downward toward case body 21. This plate is provided with a semicircular cover-side cutout 221, which is directed from the side of case body 21 toward the other edge of the case body. When case cover 22 is attached to case body 21, the aforementioned plate is inserted into case-body cutout 211 so that in the assembled state the semicircular parts of cover-side cutout 221 and case-body cutout 211 form a complete round opening.

A specific feature of the connector of the present invention is the rotation mechanism that allows turning of cartridge case 2 when external force exceeds a predetermined value with the connector 1 in a condition in which connecting projection member 12 of the connector is connected to the connection portion so that the fuel-supply opening communicates with the fuel-receiving mouth. According to the present embodiment, the aforementioned rotation mechanism of connector 1 holds connector 1 by placing annular groove 111 between circular cutout 221 of the cover and case-body cutout 211 so that the axis of annular groove 111 of large-diameter portion 11 is maintained coaxially with the aforementioned complete round opening and so that the outer peripheral surface of annular groove 111 can slide in the circumferential direction over the inner peripheral surface of the aforementioned complete round opening.

The end face of large-diameter portion 11 of connector 1, which is opposite to projection 12, is positioned in cartridge case 2 and is connected to a tubular inlet portion of fuel container 2F, which is filled with fuel and is made, e.g., in the form of a bag. Altogether, connector 1, cartridge case 2, and fuel container 2F form a fuel-cell cartridge. As a result of interaction of the rotation-stopping engagement element 112 with projection 23a of resilient element 23, in a normal state connector 1 and cartridge case 2 are prevented from rotation.

By selecting the position of engagement element 112, it becomes possible to stop rotation of cartridge case 2 in any position so that in normal use cartridge 2 is maintained in a state that allows stopping thereof in any arbitrary position but allows rotation thereof only when external force that exceeds a predetermined value is applied to cartridge case 2 in the circumferential direction.

As shown in FIG. 2, cylindrical connecting projection member 12 has equally spaced engagement teeth 124 which are intended for locking purposes and are formed on the outer periphery at the end of aforementioned projection 12. On the inner peripheral surface, cylindrical connecting projection member 12 has a reference tooth 121 that projects radially inward and extends rearward from the end face of the projection. Furthermore, cylindrical connecting projection member 12 has a plurality (two in the illustrated embodiment) of selective teeth 122 and 123 that extend rearward from the end face of projection member 12 and are located relative to the reference tooth in positions that are preset for connection to fuel-cell cartridges of different types. In the illustrated embodiment, reference tooth 121 and selective teeth 122 and 123 have different widths. Depending on the type of fuel-cell cartridge to be connected, the selective teeth may differ not only in width but also in length. Altogether, reference tooth 121 and selective teeth 122 and 123 will be further referred to as “connector-side engagement key K1”.

Although in the present invention the connector-side engagement key K1 has the above-described structure, it is understood that the invention is not limited to this specific structure, and various modifications and changes are possible. For example, the key structure may have several reference teeth 121; selective teeth 122 and 123 and reference tooth 121 may be formed on the outer periphery of the projection member 12; reference and selective teeth can be formed on both inner and outer peripheries of the projection member 12, or [the aforementioned selective and reference teeth] may have different arrangement patterns.

The connection portion of the appliance that incorporates a fuel cell (which is not shown in the drawings) has on its outer side a tubular connection element that has a fuel-receiving opening and can fit onto the outer surface of the fuel-receiving mouth. This tubular connection element has on its outer periphery a connection-portion-side reference groove, which corresponds to the aforementioned reference tooth 121, and a pair of connector-portion-side selection grooves, which correspond to aforementioned selective teeth 122 and 123. Altogether, the connector-portion-side selection groove and the connector-side reference groove form a connection-portion-side engagement key. Furthermore, the connection portion is provided with a locking element that can be removably connected to engagement teeth 124. The structure of the removable connection between the connector 1 and the aforementioned connection portion is used in a connector structure with the locking mechanism, as disclosed in earlier Japanese Unexamined Patent Application Publication (Kokai) 2006-112635. Therefore, a detailed description of this mechanism is omitted from the present patent application.

To connect the fuel-cell cartridge connector 1 of the above-described embodiment of the invention to a connection portion of the appliance that incorporates a fuel cell, the connector-side key K1 engages with the connection-portion-side key, thus connecting the fuel-receiving opening with the fuel-supply opening (not shown). At the same time, engagement teeth are engaged with and fixed by means of the connection portion. As a result, fuel contained in fuel container 2F is supplied to the fuel cell (not shown) through connector 1 and the connection portion. During this operation, only a specific connector 1 that has engagement key K1, which corresponds to the engagement key on the connection-portion side, can be attached to the aforementioned connection portion. Such construction excludes the possibility of accidentally attaching connector 1 to a wrong fuel cell cartridge since none of the cartridges can be attached except for one having an engagement key that matches the engagement key K1 of the connector.

Furthermore, it becomes possible to specify the position of reference tooth 121 if rotation-stopping engagement element 112 is formed in the position that specifies the connector-side engagement key K1 (e.g., if reference tooth 121 is formed in the position that runs parallel to the plane of cover body 22 on the side of cover body 22 of cartridge case 2). As a result, it will be possible to eliminate difficulties in connecting to the connection portion that are caused by changing the position of the connector-side engagement key K1 relative to the cartridge case 2 due to rotation of the cartridge case. It will also be possible to attach connector 1 and the connection portion to the container.

Thus, as described above, if the fuel supply port is connected to the fuel receiving port, and as shown in FIGS. 3(a) and (b), the rotation-stopping engagement element 112 engages projection 23a of resilient element 23, and if connecting projection member 12 is connected and fixed to the connection portion, application of a normal force will not disengage connector 1 and cartridge case 2 from engagement element 12 and projection 23a, whereby cartridge case 2 is not rotated. However, if the applied external force exceeds a predetermined value, projection 23a will be pressed to the bottom of engagement element 112 facing toward the bottom of case body 21, whereby, as shown in FIGS. 3(c) and (d), the rotation-stopping engagement element 112 will disengage from projection 23a of resilient element 23, and only cartridge 2 will turn in the “d” direction while connector 1 and the connection portion will remain in the fixed and connected condition. Since no force can be applied in the aforementioned rotation direction to connector 1 and the connection portion when these parts are connected and locked, the connection portion and connector 1, i.e., the appliance that contains the fuel cell and the fuel cell cartridge, are protected from damage. Thus, when a force which is applied to the cartridge case 2 in the rotation direction is below a predetermined value, engagement between engagement element 112 and projection 23a is restored, and the cartridge stops rotating.

The connector 1 of the above-described embodiment has an engagement element 112 in one location. However, the connector of the invention is not limited to this specific embodiment, and the connector may have four engagement elements located on four sides, or the like, or it may have many engagement elements located in arbitrary positions.

Furthermore, in the illustrated embodiment, engagement element 112 of connector 1 is a V-shaped notch. However, this shape should not be construed as limiting the scope of the invention, and engagement element 112 may have a semicircular shape, U-shape, triangular shape, trapezoidal shape, etc. In this case, projection 23a of resilient element 23 should have a matching semicircular, U-shape, triangular, or trapezoidal configuration.

The connection portion and connector 1 of the present embodiment are connectable through an engagement key. However, the invention is not limited to this specific feature, and connection does not require the use of an engagement key. Since in this case it is not necessary to specify the position of engagement key K1, which was used for connection purposes, the connector will not have a rotation-stopping engagement element, and the cartridge case will be constructed for free rotation. In this case, a rotating force that is able to initiate rotation of cartridge case 2 can be set by adjusting resistance to rotation of cartridge case 2.

The fuel-cell cartridge equipped with connector 1 in accordance with the second embodiment of the invention will be now described with reference to FIG. 4, which is a three-dimensional view of the fuel-cell cartridge of the second embodiment. The parts of the fuel-cell cartridge of the second embodiment that are identical to similar parts of the first embodiment will be designated by the same reference numerals, and their detailed descriptions will be omitted.

The appliance of the second embodiment differs from the appliance of the first embodiment by engagement means provided in case body 21 for engagement with engagement element 112. In this embodiment, case body 21 is provided with a rectangular tubular projection 213, which has a central opening 213a and extends upward from the bottom of case body 21 near the position of body-side cutout 211. Opening 213a has a rectangular cross-section with a long length and a short width and extends in the direction parallel to the side wall of case body 21. Inserted into aforementioned opening 213a is one end of a second resilient element 24 that comprises an engagement element and is made in the form of a thin metal plate.

The second resilient element 24 is made in the form of a V-shaped projection member 24a, which is engageable with the engaging element on the side of cutout 211 of the case body. Projection member 24a has resiliency in the projection direction. In accordance with the present embodiment of the invention, resilient element 24 is made from metal. However, the invention is not limited to this specific material, and the projection member can be made from other resilient materials, such as resin, rubber, or the like.

Similar to the first embodiment, rotation of cartridge case 2 is prevented when second projection member 24a engages with engagement element 112.

The fuel-cell cartridge equipped with connector 1 in accordance with the third embodiment of the invention will be now described with reference to FIG. 5, which is a three-dimensional view of the fuel-cell cartridge of the third embodiment. The parts of the fuel-cell cartridge of the third embodiment that are identical to similar parts of the previous embodiments will be designated by the same reference numerals, and their detailed descriptions will be omitted.

The fuel cell cartridge of the third embodiment differs from the appliance of the previous embodiment by engagement means provided in case body 21 for engagement with engagement element 112. In this embodiment, case body 21 is provided near cutout 211 with a rectangular block 25, which is attached to the bottom and the side wall of case body 21, e.g., by insertion into a slot, by screws, or by adhesion. Block 25 has a slot 25a that extends from the side nearest cutout 211 in the direction opposite cutout 211. Inserted into slot 25a is a spring 26 that has on its end that faces cutout 211 a tip member in the form of a ball 26a that is urged by spring 26 toward engagement element 112, which is located on the side of cutout 211. Altogether, rectangular block 25, spring 26, and tip member 26a form engagement means.

Similar to the previous embodiments, rotation of cartridge case 2 is prevented when spherical tip member 26a engages with engagement element 112. However, when a rotating force that exceeds a predetermined value is applied to cartridge case 2, tip member 26a is urged to the inclined surface of engagement element 112, spring 26 is compressed and shifted into slot 25a, and tip member 26a is disengaged from engagement means 112 and allows turning of the cartridge.

The fuel-cell cartridge equipped with connector 1 in accordance with the fourth embodiment of the invention will be now described with reference to FIG. 6, which is a three-dimensional view of the fuel-cell cartridge of the third embodiment. The parts of the fuel-cell cartridge of the fourth embodiment that are identical to similar parts of the previous embodiments will be designated by the same reference numerals, and their detailed descriptions will be omitted.

The fuel cell cartridge of the fourth embodiment has the same engagement means as in the third embodiment which is provided with a mechanism for adjusting the force developed by spring 26. The adjusting mechanism has a through-threaded opening 25b that extends to opening 25a formed in the block, and a screw 27 is threaded into opening 25b until it contacts the end of spring 26. Thus, the force developed by spring 26 can be easily adjusted by means of screw 27. The above-described mechanism makes it possible to precisely adjust the aforementioned predetermined force that allows turning of cartridge case 2 in accordance with the strength of the appliance that holds the fuel cell and/or parts of the fuel-cell cartridge.

Connector 1 of the above-described embodiments makes it possible to rotate cartridge case 2 in a direct or in an opposite direction. However, if in the second embodiment V-shaped projection member 24a is made as a second resilient member 24′ with a V-shaped projection 24a′ of the type shown in FIG. 7, which has a flat area on the side of the opening of case body 21, and if engagement element 112 is made as a V-shaped engagement element 112′ that has an axis substantially parallel to the diameter of the large-diameter portion 11, then rotation of cartridge case 2 will be limited only in the direction toward the area of contact between the flat portions of projection 24a′ and engagement element 112′, i.e., in the counterclockwise direction in FIG. 7. In other words, the embodiment of FIG. 7 will allow rotation of cartridge case 2 only in one direction. However, when force applied to the cartridge case exceeds a predetermined value, the inclined surface of engagement element 112′ will press onto the inclined surface of projection 24a′. This action will disengage engagement element 112′ from projection 24a′ and will allow rotation of cartridge case 2 (in the clockwise direction in FIG. 7).

If in the third and fourth embodiments tip member 26a is made as a spring 26″ shown in FIG. 8, which rigidly supports a V-shaped tip 26″ that has a flat surface on the side of the opening of the case body 21, and if engagement element 112 is made as a U-shaped engagement element 112″ having an axis substantially parallel to the diameter of the large-diameter portion 11, then similar to the above-described embodiments, rotation of cartridge case 2 will be limited only in the direction toward the area of contact between the flat portions of projection 24a″ and engagement element 112″, i.e., in the counterclockwise direction shown in FIG. 8. In other words, the embodiment of FIG. 8 will allow rotation of cartridge case 2 only in one direction.

However, when force applied to the cartridge casing exceeds a predetermined value, the inclined surface of engagement element 112″ will press onto the inclined surface of projection 24a″. This action will disengage engagement element 112″ from projection 26a″ and will allow rotation of cartridge case 2 in the clockwise direction in FIG. 8.

If in this case a rod-like handle, which is not shown in the drawing and which passes through the center of the spring, is connected to tip 26a″ on the spring side, then by rotating the handle it will be easy to change to the direction that allows turning of the cartridge case. Furthermore, by threading screw 27 into the through-threaded opening, it will be possible to restrict rotation of the cartridge case by holding the inserted tip.

### BRIEF DESCRIPTION OF THE DRAWINGS

FIG. 1 is a three-dimensional exploded view of the main part of the fuel-cell cartridge according to the first embodiment of the invention.

FIG. 2 is a three-dimensional view of the fuel-cell cartridge connector of FIG. 1.

FIG. 3 is a drawing that shows the mechanism of rotation of the connector shown in FIG. 1.

FIG. 4 is a three-dimensional exploded view of the main part of the fuel-cell cartridge according to the second embodiment of the invention.

FIG. 5 is a three-dimensional exploded view of the main part of the fuel-cell cartridge according to the third embodiment of the invention.

FIG. 6 is a three-dimensional exploded view of the main part of the fuel-cell cartridge according to the fourth embodiment of the invention.

FIG. 7 is a side view of the resilient element and the engagement element according to a specific embodiment of the invention.

FIG. 8 is a view that shows engagement means according to another specific embodiment of the invention.

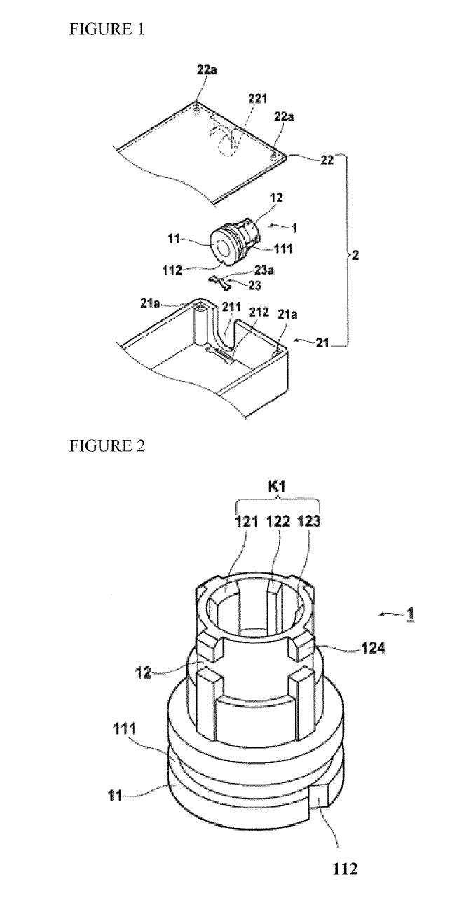

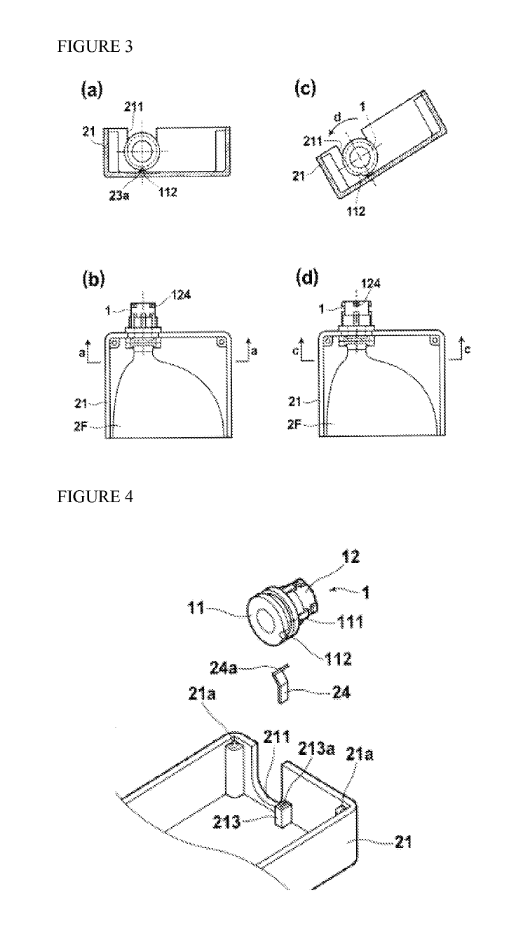

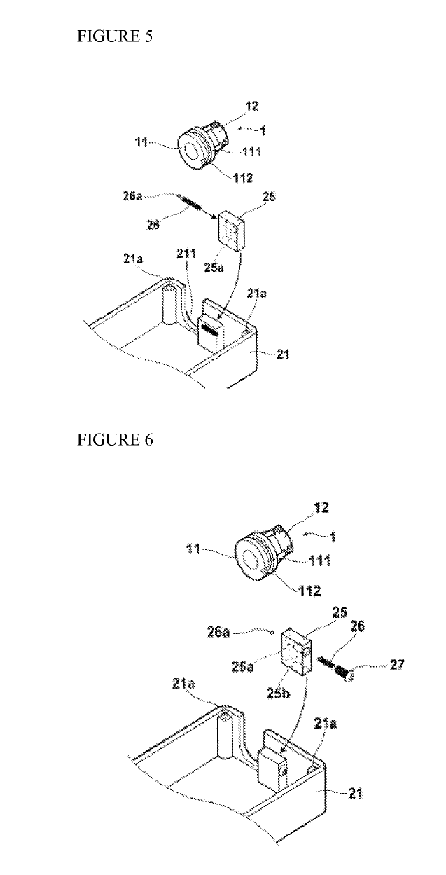

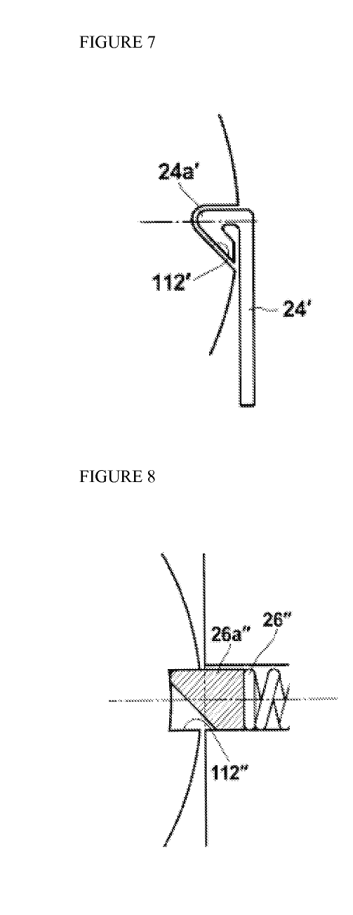

### FIGURE LEGEND

1 fuel-cell cartridge connector
11 large-diameter portion
111 annular groove
112 engagement element
12 connecting projection member
121 reference tooth
122, 123 selective teeth
2 cartridge case
21 case body
211 body-side cutout
212 recess
22 case cover
221 cover-side cutout
23, 24, 26 resilient elements
23a, 24a projection (engagement means)
26a tip (engagement means)
2F fuel container
K1 connector-side engagement key

1. A fuel-cell cartridge connector comprising:
a connecting projection member that is held in a cartridge case that covers a fuel container that contains fuel to be supplied to a fuel cell, said connecting projection member having one end for insertion into the aforementioned fuel container and the other end for contact with the front end of a fuel supply mouth and for attachment to said fuel supply mouth;
said fuel-cell cartridge connector being intended for removably connecting to an appliance that contains the aforementioned fuel cell and has a connection portion that corresponds to the connecting projection member;
said fuel-cell cartridge connector being characterized by having a rotation mechanism that allows rotation of the cartridge case relative to the connector when a rotating force that exceeds a predetermined value is applied to the cartridge when the connecting projection member is connected to the connection portion and the fuel-receiving opening communicates with the fuel supply mouth.

2. The fuel-cell cartridge connector of claim 1, wherein the aforementioned rotation mechanism comprises engagement means and a rotation-stopping engagement element that is engaged with the engagement means that are provided in the cartridge case.

3. The fuel-cell cartridge connector of claim 2, wherein the connecting projection member and the connection portion form connection engagement keys from corresponding grooves and/or projections, respectively; the aforementioned engagement element being formed in a position that is specified for said grooves and/or projections of the connection engagement keys.

4. The fuel-cell cartridge connector according to claim 2, wherein the engagement means are provided with an adjustable mechanism for setting the aforementioned predetermined value.

5. The fuel-cell cartridge connector according to claim 3, wherein the engagement means are provided with an adjustable mechanism for setting the aforementioned predetermined value.
